(19) United States
(12) Patent Application Publication
(10) Pub. No.: US 2013/0101054 A1
(43) Pub. Date: Apr. 25, 2013

(54) POWER LINE COMMUNICATION METHOD AND ELECTRONIC SYSTEM AND ELECTRONIC DEVICE USING THE SAME

(71) Applicant: CHICONY ELECTRONICS CO., LTD., New Taipei (TW)

(72) Inventors: Chien-Tsung Chen, New Taipei (TW); Shih-Hao Lu, New Taipei (TW)

(73) Assignee: CHICONY ELECTRONICS CO., LTD., New Taipei (TW)

(21) Appl. No.: 13/655,335

(22) Filed: Oct. 18, 2012

(30) Foreign Application Priority Data
Oct. 21, 2011 (TW) 100138216

(51) Int. Cl. H04B 3/54

(52) U.S. Cl. 375/257

(57) ABSTRACT

The present application discloses a power line communication method and an electronic system and an external device using the same. The external device using the power line communication method is electrically connected to an electronic device via a transmit line and comprises: a voltage detecting module configured to detect a voltage variance of a signal voltage supplied by the electronic device; a processing module retrieving a message according to the voltage variance and processing the message to generate a message to be transmitted; and a load modulation module having a load and modulating a load value of the load according to the message to be transmitted.

### CROSS-REFERENCE TO RELATED APPLICATION

This non-provisional application claims priority under 35 U.S.C. §119(a) on Patent Application No. 100138216 filed in Taiwan (R.O.C.) on Oct. 21, 2011, the entire contents of which are hereby incorporated by reference.

### BACKGROUND OF THE INVENTION

1. Field of the Invention

The present application relates to an electronic system and an electronic device, and more particularly, to a power line communication method and an electronic system and an electronic device using the same.

2. Description of the Prior Art

Currently, the commonly used line communication interfaces, such as Universal Asynchronous Receiver/Transmitter (UART), Serial Peripheral Interface (SPI), Inter-Integrated Circuit (IIC), etc. require additional communication lines in addition to two essential power lines (VCC and GND). For example, RS232 requires two transmission lines (T×D and R×D), SPI requires three transmission lines (DIN, DOUT and CLOCK), and IIC requires two transmission lines (DATA and CLOCK).

With the rapid development and advances in communication technology and Internet technology, the power line communication technology employed in data transmission has gradually moved toward a mature stage. The power line technology involves, for example, loading a high-frequency signal carrying information to a power line, separating the high-frequency signal from the power line through the dedicated power line modulation/demodulation technology and transmitting the high-frequency signal to a terminal equipment, thereby the signal can be retrieved from the power line. However, such technique is too costly.

Therefore, a need exists in the art for a power line communication method characterized in that the power line retains the transmission function while costing less.

### SUMMARY OF THE INVENTION

The present application relates to a power line communication method and an electronic system and an external device using the same. This method employs two power lines to transmit signals and can be applied to external device and system.

According to an aspect of the present invention, there is provided an external device using a power line communication method, and characterized in that the external device is electrically connected to an electronic device via a transmission line and comprises: a voltage detecting module configured to detect a voltage variance of a signal voltage supplied by the electronic device; a processing module retrieving a message according to the voltage variance and processing the message to generate a message to be transmitted; and a load modulation module having a load and modulating a load value of the load according to the message to be transmitted.

According to another aspect of the present invention, there is provided an electronic system using a power line communication method and comprising: an electronic device configured to supply a signal voltage; and an external device electrically connected to the electronic device via a transmission line. The external device comprises a voltage detecting module configured to detect a voltage variance of the signal voltage supplied by the electronic device, a processing module retrieving a message according to the voltage variance and processing the message to generate a message to be transmitted, and a load modulation module having a load and modulating a load value of the load according to the message to be transmitted.

According to yet another aspect of the present invention, there is provided a power line communication method comprising: detecting a voltage variance of a signal voltage supplied to an external device from an electronic device electrically connected to the external device via a transmission line; retrieving a message according to the voltage variance and generating a message to be transmitted according to the message; and modulating a load of a load modulation module according to the message to be transmitted.

The present invention will be described by way of a preferred embodiment by referring to the accompanying drawings so as to facilitate the understanding of the aforementioned contents.

### BRIEF DESCRIPTION OF THE DRAWINGS

FIG. 1 shows a framework of an electronic system in accordance with an embodiment of the present invention.

FIG. 2 is a flow chart illustrating a power line communication method in accordance with an embodiment of the present invention.

### DETAILED DESCRIPTION OF THE PREFERRED EMBODIMENTS

While the present invention will be fully described by way of a preferred embodiment by referring to the accompanying drawings, it is to be understood beforehand that those skilled in the art can make modifications to the invention described and attain the same effect, and that the description below is a general representation to those skilled in the art and is not intended to limit the scope of the present invention.

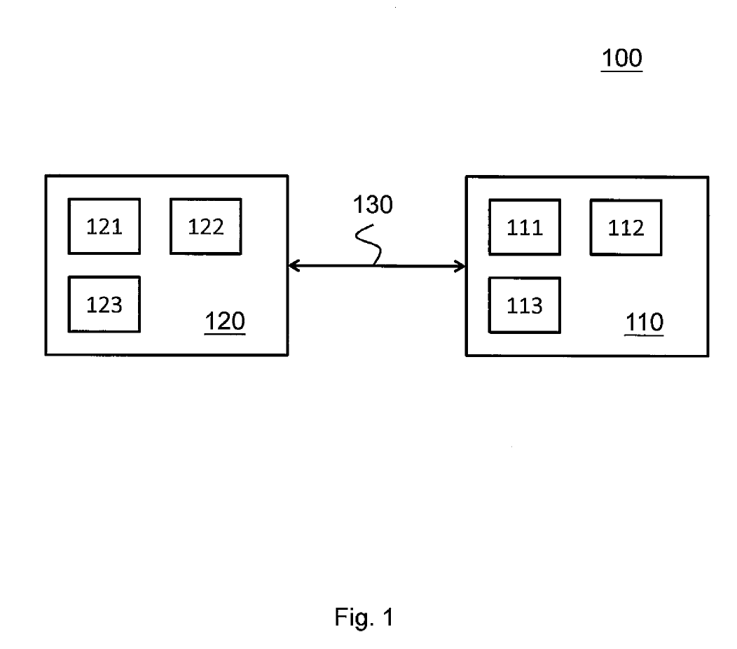

FIG. 1 shows a framework of an electronic system 100 in accordance with an embodiment of the present invention. The electronic system 100 is, for example, an electronic system using a power line communication method. In the embodiment of the present invention, the electronic system 100 comprises, for example, an external device 110, an electronic device 120 and a transmission line 130. In an embodiment, the external device 110 is, for example, an external device using a power line communication method and comprising, for example, a voltage detecting module 111, a processing module 112 and a load modulation module 113. The electronic device 120 comprises, for example, a current detecting module 121, a processor 122 and a voltage modulation module 123. The transmission line 130 is configured, for example, to electrically connect the external device 110 to the electronic device 120.

The voltage detecting module 111 comprises, for example, a resistance, and a voltage value of the voltage coupled to the voltage detecting module 111 can be obtained by detecting the voltage drop across the resistance. In an embodiment, an IC of an ADC can be used to detect the voltage. In an embodiment, when the electronic device 120 is coupled to the external device 110 via the transmission line 130 and supplies a signal voltage, the voltage detecting module 111 can detect a voltage variance of the signal voltage supplied by the electronic device 120.

The processing module 112 is, for example, a microprocessor. In an embodiment, the processing module 112 can further comprise a storage unit and process the data transmitted thereto according a correspondence table or a calculation formula stored in the storage unit to retrieve a message. In an embodiment, the processing module 112 can retrieve a message according to a voltage variance transmitted by the voltage detecting module 111 and process the message to generate a signal to be transmitted. For example, the signal voltage may be at a high potential level or a low potential level. When the signal voltage is at a high potential level, the transmitted signal is, for example, “1”. When the signal voltage is at a low potential level, the transmitted signal is, for example, “0”. In this way, a two bit data stream can be obtained by acquiring the voltage variance of the signal voltage and thereby to obtain a data message according to the encoding method of the data.

While the signal to be transmitted is depicted as being generated by the processing module 112, it may be generated by any other module. For example, if the external device 110 is a mouse, the signal to be transmitted can, for example, be generated by the left button or the right button of the mouse. The generation of any message to be transmitted by the external device 110, e.g. through the clicking on the right button, falls within the scope of the present invention, no matter whether it is effected by the processing module 112.

For example, the load modulation module 113 can have a load comprising, for example, a large resistance and a small resistance. The load modulation module 113 can modulate a load value of the load according to the message to be transmitted. In an embodiment, a high current value and a low current value at the transmission line 130 can be generated through the alternating coupling to the small resistance and large resistance so that the message to be transmitted is transmitted with a high current value or a low current value.

For example, when the load modulation module 113 modulates the load, through e.g. the coupling to the large resistance, according to the content of the message to be transmitted, the load value of the load modulation module 113 will, for example, be greater so that the current value of the transmission line 130 will be smaller when the signal voltage remains constant. When the load modulation module 113 modulates the load, through e.g. the coupling to the small resistance, the load value of the load modulation module 113 will, for example, be smaller so that the current value of the transmission line 130 will be greater when the signal voltage remains constant. In this way, a high current value and a low current value at the transmission line 130 are generated through the alternating coupling to the small resistance and large resistance, and the high current value and the low current value correspond respectively to messages, e.g. “1” and “0”.

In other words, the current value of the transmission line 130 changes according to the load value modulated by the load modulation module 113. That is, the current value of the transmission line 130 is changed through the modulation of the load value by the load modulation module 113, thereby the external device 120 can obtain the message to be transmitted.

The electronic device 120 can comprise a current detecting module 121, a processor 122 and a voltage modulation module 123. The voltage modulation module 123 is configured, for example, to output a signal voltage. The current detecting module 121 is configured, for example, to detect a high current value and a low current value at the transmission line 130 so as to retrieve the message to be transmitted.

When the voltage modulation module 123 transmits a signal voltage to the voltage detecting module 111 via the transmission line 130, the voltage detecting module 111 can detect a variance of the signal voltage and transmit the variance to the processing module 112. The processing module 112 retrieves a message according to the variance by reference to a correspondence table or a formula. When the external device 110 generates a message to be transmitted, the magnitude of the current flowing through the transmission line 130 is modulated, for example, by the load modulation module 113 so that the current detecting module 121 of the electronic device 120 can retrieve the message to be transmitted according to the variation in magnitude of the current flowing through the transmission line 130.

The processor 122 of the electronic device 120 can generate a new message according to the retrieved message to be transmitted, and the voltage modulation module 123 generates a new signal voltage according to the new message. This new signal voltage also has a high voltage value and a low voltage value to represent this message. The processing module 112 of the external device 110 can retrieve the new message according to a voltage variance of the signal voltage having a high voltage value and a low voltage value.

In this way, the external device 110 and the electronic device 120 can transmit messages to each other by controlling the variation in voltage and current on the transmission line 130.

In an embodiment, the signal voltage can be a direct current (DC). In another embodiment, the signal voltage can be an alternating current. The signal voltage types are not limited herein. Any voltage supply with a voltage variation falls within the scope of the present invention.

The message transmission method, i.e. the encoding method for the message and the message to be transmitted, utilized may be Manchester encoding, Pulse Width Modulation encoding or Miller encoding.

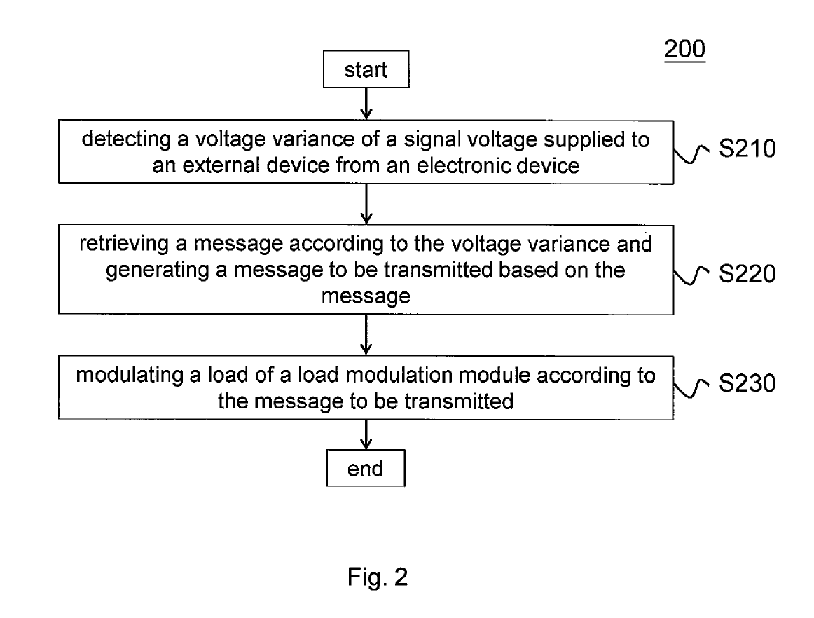

FIG. 2 is a flow chart illustrating a power line communication method 200 in accordance with an embodiment of the present invention. Please also refer to FIG. 1. In step S210, a voltage variance of a signal voltage supplied to an external device 110 from an electronic device 120 is detected, wherein the electronic device 120 is electrically connected to the external device 110 via a transmission line 130.

In step S220, a message is retrieved according to the voltage variance and a message to be transmitted is generated based on the message. For example, the signal voltage can have a high voltage level and a low voltage level corresponding respectively to “1” and “0”. In this way, the message can be retrieved by acquiring the time when the signal voltage shifts to the relatively high voltage level and the relatively low voltage level. The message to be transmitted can be generated based on the message. Alternatively, the message to be transmitted to the external device 120 can be generated in other ways. The generation of the message to be transmitted falls within the scope of the present invention whether or not it is effected based on the message.

In step S230, a load of a load modulation module 113 is modulated according to the message to be transmitted. While the load can be modulated through the coupling to the large resistance or the small resistance, as described above, any method utilized to modulate the load falls within the scope of the present invention. In this way, the electronic device 120 can transmit a message to the external device 110 by modulating the voltage on the transmission line 130, and the external device 110 can transmit a message to the electronic device 120 by modulating the current on the transmission line 130 with a load modulation method. The external device 110 and the electronic device 120 can communicate by transmitting messages to each other.

Moreover, the electronic device 120 and the external device 110 can communicate by transmitting data to each other not only through half duplex operation but also through full duplex operation.

For example, the voltage modulation module 123 can control the voltage on the transmission line 130 to be 1.9 V and 3.6 V, and the load modulation module 113 can control the load to be 1Ω and 2Ω. When the voltage modulation module 123 modulates the voltage to transmit a message, the load modulation module 113 can modulate the load to transmit a message at the same time. That is, when the current is 1.9 A or 3.6 A, the message to be transmitted by the external device 110 is, for example, “0”; when the current is 0.95 A or 1.8 A, the message to be transmitted by the external device 110 is, for example, “1”. In this way, the electronic device 120 and the external device 110 can transmit data through full duplex operation.

In conclusion, as the power line communication method and the electronic system and the external device using the same disclosed by the present invention can transmit messages through two power lines without the use of any data line required by a conventional power line, the current four-strand copper-based USB cable can be modified to be a general two-strand aluminum-based cable (or iron-based cable). In addition, the technique can be applied to the automatic test in a wireless keyboard and mouse factory. With the present invention, the internal data can be retrieved directly through the two power lines of the mouse. The present invention can even make an article under test enter the testing mode for, for example, reading chip ID, version number, etc., or can control the article under test to enter the testing mode so that no communication interface is required and the article under test has additional pins for testing. Such arrangement can reduce the testing cost and increase the test yield of the products.

While this invention has been described by way of a preferred embodiment, it is to be understood that the present invention is not limited hereto. A person having ordinary skill in the art can make various alterations and modifications herein without departing from the spirit and scope of the present invention. The scope of protection of the present invention is defined by the appended claims.

What is claimed is:

1. An external device using a power line communication method, and characterized in that the external device is electrically connected to an electronic device via a transmission line and comprises:
a voltage detecting module configured to detect a voltage variance of a signal voltage supplied by the electronic device;
a processing module retrieving a message according to the voltage variance and processing the message to generate a message to be transmitted; and
a load modulation module having a load and modulating a load value of the load according to the message to be transmitted.

2. The external device according to claim 1, wherein a current value at the transmission line changes according to the load value modulated by the load modulation module.

3. The external device according to claim 2, wherein the load comprises a large resistance and a small resistance, and a high current value and a low current value at the transmission line are generated through the alternating coupling to the small resistance and the large resistance so that the message to be transmitted is transmitted with the high current value or the low current value.

4. The external device according to claim 2, wherein the current value of the transmission line is changed with the load value modulated by the load modulation module, and thereby the electronic device obtains the message to be transmitted.

5. The external device according to claim 1, wherein the signal voltage is a direct current (DC).

6. The external device according to claim 1, wherein an encoding method for the message and the message to be transmitted is, for example, Manchester encoding, Pulse Width Modulation encoding or Miller encoding.

7. An electronic system using a power line communication method, and comprising:
an electronic device configured to supply a signal voltage; and
an external device electrically connected to the electronic device via a transmission line and comprising:
a voltage detecting module configured to detect a voltage variance of the signal voltage supplied by the electronic device;
a processing module retrieving a message according to the voltage variance and processing the message to generate a message to be transmitted; and
a load modulation module having a load and modulating a load value of the load according to the message to be transmitted.

8. The electronic system according to claim 7, wherein a current value at the transmission line changes according to the load value modulated by the load modulation module.

9. The electronic system according to claim 8, wherein the load comprises a large resistance and a small resistance, and a high current value and a low current value at the transmission line are generated through the alternating coupling to the small resistance and the large resistance so that the message to be transmitted is transmitted with the high current value or the low current value.

10. The electronic system according to claim 9, wherein the electronic device comprises:
a processor; and
a voltage modulation module configured to output the signal voltage.

11. The electronic system according to claim 10, wherein the electronic device further comprises a current detecting module configured to detect the high current value and the low current value at the transmission line so as to retrieve the message to be transmitted.

12. The electronic system according to claim 11, wherein the processor generates a new message based on the retrieved message to be transmitted, and the voltage modulation module generates a new signal voltage having a high voltage value and a low voltage value according the new message, and wherein the processing module retrieves the new message according to a voltage variance of the new signal voltage having the high voltage value and the low voltage value.

13. The electronic system according to claim 7, wherein the signal voltage is a direct current (DC).

14. The electronic system according to claim 7, wherein an encoding method for the message and the message to be transmitted is, for example, Manchester encoding, Pulse Width Modulation encoding or Miller encoding.

15. A power line communication method, comprising:
detecting a voltage variance of a signal voltage supplied to an external device from an electronic device electrically connected to the external device via a transmission line;
retrieving a message according to the voltage variance and generating a message to be transmitted based on the message; and
modulating a load of a load modulation module according to the message to be transmitted.

16. The power line communication method according to claim 15, wherein a current value at the transmission line changes according to the load value modulated by the load modulation module.

17. The power line communication method according to claim 16, wherein the external device comprises a large resistance and a small resistance, and a high current value and a low current value at the transmission line are generated through the alternating coupling to the small resistance and the large resistance so that the message to be transmitted is transmitted with the high current value or the low current value.

18. The power line communication method according to claim 15, wherein the signal voltage is a direct current (DC).

19. The power line communication method according to claim 15, wherein an encoding method for the message and the message to be transmitted is, for example, Manchester encoding, Pulse Width Modulation encoding or Miller encoding.
